(19) United States
(12) Patent Application Publication
(10) Pub. No.: US 2024/0085327 A1
(43) Pub. Date: Mar. 14, 2024

(54) MEASURING METHOD, MEASURING APPARATUS, AND STORAGE MEDIUM

(71) Applicant: CANON KABUSHIKI KAISHA, Tokyo (JP)

(72) Inventors: TAKAHIRO MASUMURA, Tochigi (JP); NORISHIGE KAKEGAWA, Tokyo (JP)

(21) Appl. No.: 18/363,849

(22) Filed: Aug. 2, 2023

(30) Foreign Application Priority Data
Sep. 13, 2022 (JP) 2022-145660

(51) Int. Cl. G01N 21/64

(52) U.S. Cl. CPC G01N 21/6428; G01N 21/6445

(57) ABSTRACT

A measuring method includes a first sequence for acquiring a first result about the anisotropy by performing a dispensing step and a measuring step and for measuring concentration of the measurement object from the first result based on a relationship between the anisotropy and a dispensing amount of the fluorescent reagent dispensed in the dispensing step, and a second sequence for acquiring a second result about the anisotropy by performing the dispensing step and the measuring step one or more times after the first sequence and for measuring the concentration of the measurement object from the second result based on the relationship between the anisotropy measured in the measuring step and the dispensing amount of the fluorescent reagent dispensed in the dispensing step.

### BACKGROUND

### Technical Field

One of the aspects of the embodiments relates to a measuring method.

### Description of Related Art

The fluorescence polarization (method) utilizing the polarization characteristic of fluorescence is known as a sample testing method that utilizes antigen-antibody reaction. The fluorescence polarization irradiates linearly polarized excitation light on a mixture (reaction solution) of a test sample containing an inspection item (object or target to be measured or a measurement object) and a fluorescent reagent, measures the fluorescent intensity emitted from the reaction solution through the polarization division, and evaluates the polarization degree (polarization anisotropy or anisotropy). Japanese Patent No. 1692254 discloses an analyzing apparatus using the fluorescence polarization. This anisotropy value is very sensitive to the rotational movement of the measurement object, and the rotational movement depends on the size of the measurement object. In the antigen-antibody reaction, in a case where a measurement object (antigen) and a reagent modified with an antibody are mixed, the antigen and the antibody specifically react and bind to form an aggregate. Therefore, measuring the anisotropy can detect the size change (agglutination reaction) of the measurement object with high sensitivity. A relationship between the size change of the measurement object and the measured anisotropy depends on a concentration relationship between the measurement object and the reagent. Using a known reagent amount and previously obtaining the relationship between the concentration of the measurement object and the measured anisotropy as a calibration curve can calculate the concentration of the measurement object using the result of the anisotropy measurement.

Optimally adjusting a reagent amount to be mixed enables the fluorescence polarization to measure a very low concentration of the measurement object with high sensitivity. However, the reagent condition adjusted for high-sensitivity detection in this way has a problem in that the measurable concentration range is limited to the low-concentration region. In a case where the concentration of the measurement object exceeds the concentration range, an anisotropy value saturates at a constant value regardless of the concentration of the measurement object, and the fluorescence polarization loses sensitivity to the concentration of the measurement object. Conversely, in a case where the reagent amount is adjusted so that the high-concentration region can be measured, the measurement sensitivity in the low-concentration region lowers. Thus, the fluorescence polarization has a problem in that it cannot achieve both high sensitivity and a wide measuring range.

### SUMMARY

A measuring method according to one aspect of the embodiment includes a dispensing step of dispensing fluorescent reagent into a measurement object, a measuring step of irradiating light onto a reaction solution in which the measurement object and the fluorescent reagent are mixed, and of measuring anisotropy of fluorescent light emitted from the reaction solution, a first sequence for acquiring a first result about the anisotropy by performing the dispensing step and the measuring step and for measuring concentration of the measurement object from the first result based on a relationship between the anisotropy and a dispensing amount of the fluorescent reagent dispensed in the dispensing step, and a second sequence for acquiring a second result about the anisotropy by performing the dispensing step and the measuring step one or more times after the first sequence and for measuring the concentration of the measurement object from the second result based on the relationship between the anisotropy and the dispensing amount of the fluorescent reagent dispensed in the dispensing step. A measuring apparatus corresponding to the above measuring method also constitutes another aspect of the embodiment. A storage medium storing a program that causes a computer to execute the above measuring method also constitutes another aspect of the embodiment.

Further features of the disclosure will become apparent from the following description of embodiments with reference to the attached drawings.

### BRIEF DESCRIPTION OF THE DRAWINGS

FIG. 1 illustrates an example of a measuring range of a fluorescence polarization measuring method.

FIGS. 2A and 2B schematically illustrate states of a measurement object, fluorescent body, and aggregates thereof in a reaction solution under different concentration conditions.

FIG. 3 is a configuration diagram of a fluorescence polarization analyzing apparatus according to a first embodiment.

FIG. 4 illustrates a measurement and analysis flow according to the first embodiment.

FIGS. 5A and 5B schematically illustrate a relationship between measurement time and changes in anisotropy for first dispensing and additional dispensing.

FIGS. 6A and 6B schematically illustrate a first calibration curve and a second calibration curve.

FIG. 7 is a configuration diagram of a fluorescence polarization measuring apparatus according to a second embodiment.

### DESCRIPTION OF THE EMBODIMENTS

Referring now to the accompanying drawings, a detailed description will be given of embodiments according to the disclosure. Corresponding elements in respective figures will be designated by the same reference numerals, and a duplicate description thereof will be omitted.

### DESCRIPTION OF PRINCIPLE AND PROBLEM OF THE PRESENT DISCLOSURE

The fluorescence polarization measuring method according to the present disclosure mixes a test sample such as blood or urine collected from a human specimen with a reagent and measures the concentration of a desired test item (item to be detected or measurement object) contained in the test sample. The reagent contains a fluorescent body (fluorescent molecule), and the fluorescent body is modified with an antibody. This antibody specifically reacts with an antigen (measurement object) contained in the test sample, and a reagent containing a fluorescent body (fluorescent reagent) agglutinates via the antigen. Quantifying the aggregation degree can measure the concentration of the measurement object. In this quantification, the fluorescence polarization measuring method according to the present disclosure evaluates the aggregation degree by measuring the polarization dependency of the fluorescent intensity and calculating a parameter called the polarization degree (anisotropy). More specifically, this method irradiates the reaction solution with linearly polarized excitation light, measures a fluorescent intensity I// of polarized light parallel to the polarization direction of the excitation light and a fluorescent intensity I⊥ of polarized light perpendicular to the polarization direction of the excited light for the fluorescent light emitted from the reaction solution, and calculates the anisotropy r according to the following equation (1) using the two measurement results:

r=(I//−I⊥)/(I//+2I⊥) (1)

Alternatively, the anisotropy r may be calculated according to the following equation (2):

r=(I//−I⊥I)/(I//+I⊥) (2)

The fluorescent body absorbs, excites, and emits light according to a relative relationship between the polarization direction of the excitation light and the orientations of the fluorescent molecules (molecular axis). On the other hand, the fluorescent body rotates and translates in the reaction solution due to the Brownian motion. Now, in the light emission process of the fluorescent body, if the rotation of the fluorescent body is sufficiently slower in view of the fluorescence lifespan and the influence of the rotation is negligible, the light is absorbed by the molecular axis parallel to the excitation light and light is emitted. Therefore, the fluorescent intensity of the polarized light parallel to the excitation light is most significantly measured. Conversely, if the rotational motion of the fluorescent body is much faster than the fluorescence lifespan, the measured fluorescent light is unpolarized due to the random rotation of the fluorescent body between light absorption and light emission. In an intermediate state between these states, if the fluorescence lifespan and the rotational motion are approximately equivalent, the measured fluorescent light has a polarization characteristic because the rotating fluorescent body emits light while maintaining the polarization direction of the excitation light to some extent. The fluorescence polarization measuring method recognizes a change in the rotational motion of the fluorescent body caused by the agglutination reaction by measuring the anisotropy of the fluorescence under this condition. This rotational motion depends on the volume of the fluorescent body (cubed size) and is therefore very sensitive to changes in fluorescent body size. Using this principle can measure the aggregation degree of the reaction solution (change in size of the measurement object) with high sensitivity even for a measurement object of very low concentration. A relationship between the size change of the measurement object and the anisotropy r to be measured depends on a concentration relationship between the measurement object and the reagent. Once a known amount of reagent is used and the relationship between the concentration of the measurement object and the anisotropy r to be measured is previously obtained as a calibration curve, the concentration of the measurement object can be calculated from the measurement result of the anisotropy r.

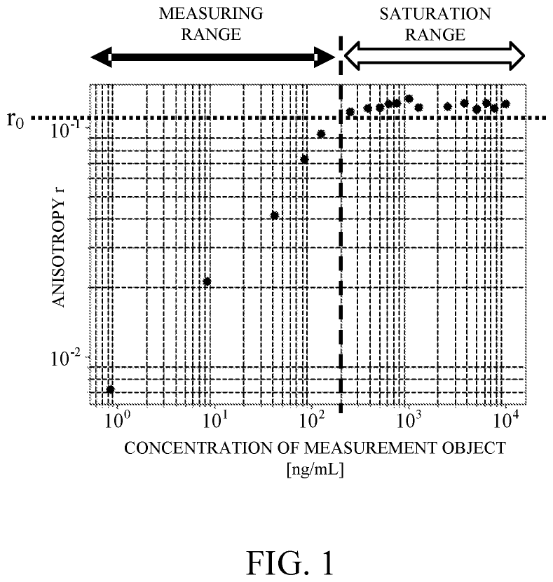

However, this anisotropy r has an upper limit value and is to be measured within a range that does not reach the upper limit. FIG. 1 illustrates measurement results of the concentration of a certain measurement object using the fluorescence polarization measuring method. A horizontal axis represents the concentration of the measurement object in the reaction solution, and a vertical axis is the anisotropy r. In FIG. 1, in a range where the anisotropy r changes according to the concentration of the measurement object (measuring (or measurable) range in FIG. 1), the measurement result of the anisotropy r and the concentration of the measurement object correspond one to one and the concentration of the measurement object can be calculated from the anisotropy r. However, in a case where the anisotropy r exceeds a certain upper limit value r0, the anisotropy r becomes a constant value relative to the concentration of the measurement object (saturation range in FIG. 1), so the concentration is calculated from the anisotropy value. That is, as long as the value of the anisotropy r is smaller than the upper limit value r0, the concentration can be quantified, and if the of the anisotropy r is equal to or larger than r0, the anisotropy is saturated and the concentration cannot be measured. In the example of FIG. 1, it is understood that the measuring range of concentration is approximately two orders of magnitude. The low-concentration limit in the measuring range is determined by the S/N of the fluorescent intensity to be measured.

Here, the measuring range can be shifted to the high-concentration side by adjusting the reagent amount of the fluorescent body for the reaction. However, in that case, the measurement sensitivity on the low-concentration side is sacrificed, and the characteristic of the fluorescence polarization measuring method cannot be utilized.

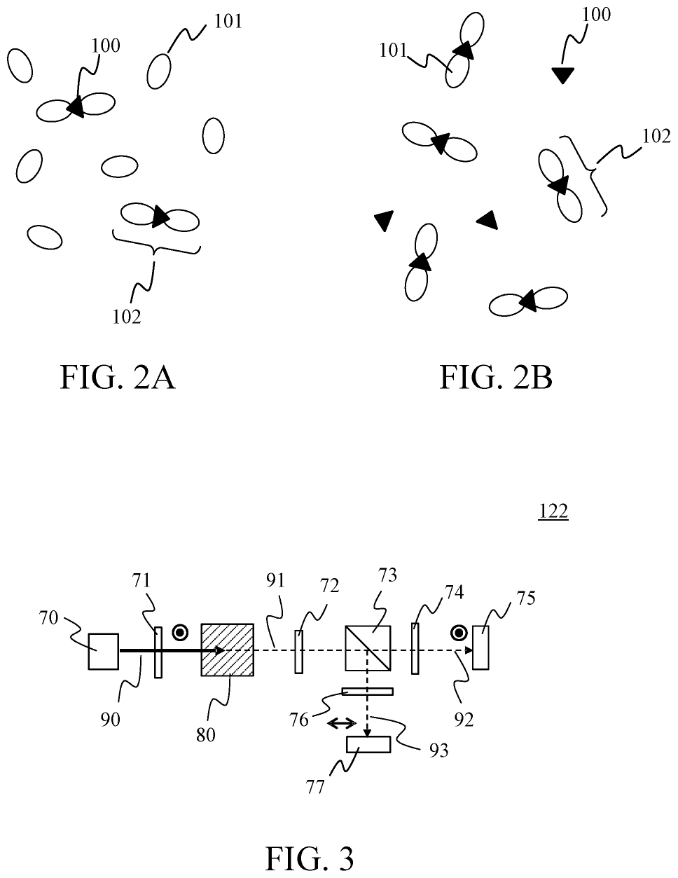

The upper limit of the anisotropy r depends on which of the light emission of the fluorescent body in the aggregated state and the light emission of the fluorescent body in the unaggregated and free state has a greater contribution to the fluorescent intensity to be measured. FIGS. 2A and 2B schematically illustrate states of a measurement object 100, a fluorescent body 101, and their aggregate 102 in a reaction solution. Now assume that the rotation relaxation time of the free fluorescent body 101 is sufficiently shorter (the rotation is faster) than the fluorescence lifespan of the fluorescent body 101. In other words, with the fluorescent body 101 alone, the fluorescent light becomes almost nonpolarized due to the rotation, and the anisotropy to be measured is very small. FIG. 2A illustrates fluorescent bodies 101 as reagents more than the measurement objects 100. At this time, the anisotropy is the result of adding two contributions of the light emission from the free fluorescent body 101 and the light emission from the fluorescent body in the aggregate 102. This situation corresponds to a range where the anisotropy to be measured changes according to the concentration of the measurement object 100 under the condition of the measuring range illustrated in FIG. 1. On the other hand, FIG. 2B illustrates a state in which there are fluorescent bodies 101 are fewer than the measurement objects 100, and the fluorescent light to be measured is mostly one emitted from the aggregate 102. The anisotropy to be measured at this time has approximately the maximum value under this condition. This is the state of the saturation range illustrated in FIG. 1. In this state, even if the concentration of the measurement object 100 becomes higher, the fluorescent light to be measured remains emitted from the aggregate 102, so the anisotropy value does not change.

One of the objects of the present disclosure is to measure the concentration of the measurement object 100 as an anisotropic change even in the state of FIG. 2B. In the present disclosure, in the state of the saturation range illustrated in FIG. 2B, the fluorescent body 101 as the reagent is additionally dispensed. The added fluorescent body 101 forms an aggregate 102 if there is a measurement object 100 as a reaction partner. In this case, the anisotropy to be measured does not change. As more fluorescent bodies 101 are additionally dispensed, the fluorescent bodies 101 becomes more than the measurement objects 100 at some point as illustrated in FIG. 2A. That is, the anisotropy value to be measured decreases from the saturation value. The additional reagent amount required for the anisotropy to start decreasing from the saturation value depends on the concentration of the measurement object 100. In a case where the concentration of the measurement object 100 is higher, more fluorescent bodies 101 are additionally dispensed accordingly. Therefore, the concentration of the measurement object 100 in the saturation range of FIG. 1 can be quantified based on the additionally dispensed reagent amount (or the total dispensed reagent amount) required for the anisotropy r to fall below the saturation value r0. We have conducted verification experiments and confirmed that the concentration of the measurement object can actually be calculated even in the saturation range described above.

### First Embodiment

Referring now to FIG. 3, a description will be given of a fluorescence polarization analyzing apparatus according to a first embodiment of the present disclosure. FIG. 3 illustrates a fluorescence polarization analyzing apparatus 122 according to this embodiment. Alight source 70 is a light source configured to emit light having a wavelength that excites the fluorescent bodies as the reagent. The wavelength of the light source can be properly selected according to the excitation wavelength of the fluorescent body. For example, light in the visible band to near-infrared band with a wavelength of 400 to 1100 nm may be used, light in the ultraviolet band with a wavelength of 400 nm or lower, or light in the infrared band with a wavelength of 1100 nm or higher may be used. The light source 70 can use an LED or a laser. This embodiment may use monochromatic light with a relatively narrow wavelength width, but may use white light, if necessary.

Excitation light 90 emitted from the light source 70 passes through a polarizing filter 71 and enters, as linearly polarized excitation light, a reaction solution 80 contained in a reaction container. As illustrated in FIGS. 2A and 2B, the reaction solution 80 contains a mixture of a test sample containing measurement objects and a reagent containing fluorescent bodies modified with antibodies that specifically react with the measurement object. Aggregates are generated in the reaction solution 80 depending on conditions such as the sizes and concentrations of the measurement object and the fluorescent body, the time after mixing the measurement object and the reagent (reaction time), and the temperature of the reaction solution 80, and the like. The reaction solution 80 is agitated by an agitator (not illustrated) after the test sample and the reagent are dispensed, so that the measurement objects and the reagents are uniformly dispersed in the reaction solution 80.

The fluorescent body of the reagent can be properly selected and designed, including a combination of characteristics such as an absorption wavelength, an emission wavelength, fluorescent emission efficiency, and fluorescent lifespan, and an antibody that specifically reacts with the measurement object. In particular, the fluorescent body of the reagent may have a fluorescent lifespan of approximately the same order as the rotational relaxation time determined by the sizes of the measurement object and aggregate.

The excitation light 90 incident on the reaction solution 80 excites the fluorescent body while propagating through the reaction solution 80, causing fluorescent light to be emitted. Although the excitation light 90 and fluorescent light 91 are emitted from the reaction solution 80, the excitation light 90 is cut by an excitation light cut filter 72 and only the fluorescent light 91 transmits through the excitation light cut filter 72. The fluorescent light 91 is split by a half-mirror 73, one of which enters a polarizing filter 74 and the other enters a polarizing filter 76. The polarizing filters 74 and 76 are arranged parallel to and perpendicular to the plane of polarization of the polarizing filter 71, respectively. Therefore, the intensity I// of fluorescent light 92 as a polarized light component parallel to the polarization of the excitation light 90 that has transmitted through the polarizing filter 74 is measured by a detector 75. On the other hand, the intensity II of fluorescent light 93 as a polarized light component perpendicular to the polarization of the excitation light 90 that has transmitted through the polarizing filter 76 is measured using a detector 77. From the light intensities obtained from the two detectors 75 and 77, the anisotropy r can be calculated using equation (1). Here, the detectors 75 and 77 may be single sensors such as photodiodes, avalanche photodiodes (APDs), or photomultiplier tubes (PMTs), or array sensors such as CCD sensors or CMOS sensors.

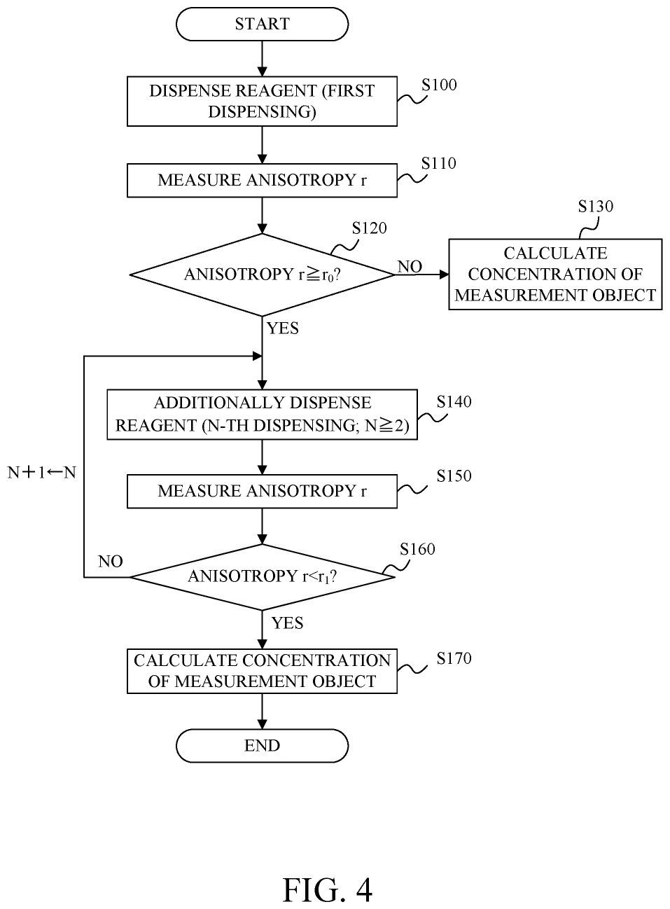

Referring now to a flow of FIG. 4, a description will be given of a measuring and analyzing method according to this embodiment using the apparatus configured as described above. FIG. 4 illustrates the measuring and analyzing flow according to this embodiment.

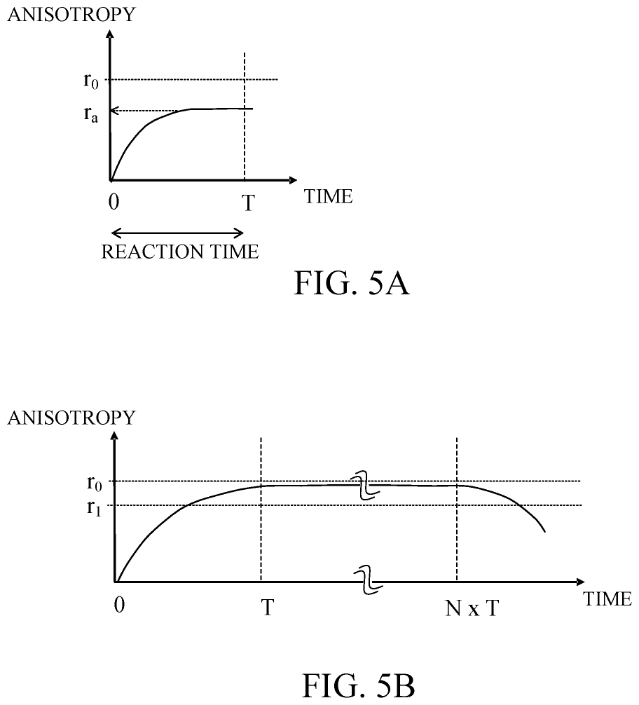

In step S100, a certain amount of a reagent containing a fluorescent body (fluorescent reagent) at a predefined concentration is dispensed (first dispensing) into a reaction container containing a test sample containing an measurement object. After dispensing and agitation by the agitator, the anisotropy r is measured in step S110. Next, in step S120, it is determined whether or not the measured anisotropy r is equal to or larger than the anisotropy saturation value 1-0 (first predetermined value). In a case where the measurement result is smaller than the saturation value 1-0, the concentration of the measurement object is within the measuring range illustrated in FIG. 1 and, in step S130, the concentration of the measurement object is calculated from the anisotropy value obtained in the first dispensing. Here, as illustrated in FIG. 5A, the anisotropy r may be evaluated by measuring the anisotropy r multiple times using a function of the anisotropy r relative to the reaction time T after the measurement object and the reagent are mixed. A value of anisotropy ra when the reaction has sufficiently converged can be set as the anisotropy value in the first dispensing. The concentration of the measurement object is calculated from the measurement result based on the previously measured calibration curve. Using a standard sample containing a measurement object with a known concentration, a correspondence relationship between the concentration of the measurement object and the anisotropy value is previously measured under the same concentration and dispensing amount as in the first dispensing, and the result is set to the first calibration curve. The saturation value 1-0 of the anisotropy r may be set based on this first calibration curve. This saturation value 1-0 can also be set to a value sufficiently small below (separate from) the saturation range. The saturation value 1-0 may be set such that the anisotropy change is sufficiently sensitive to changes in the measured concentration.

In a case where it is determined in step S120 that the measured anisotropy r is equal to or larger than the saturation value 1-0, the flow proceeds to step S140 to additionally dispense the reagent with a predefined concentration and a predefined amount (N-th dispensing; N≥2). Here, the additional dispensing may be performed under the same condition (reagent concentration, amount to be dispensed) as that of the first dispensing in step S100, or may be different from that of the first dispensing set for the additional dispensing. After the additional dispensing in step S140, the anisotropy r of the agitated reaction solution is measured again in step S150. In step S160, it is determined whether or not the measured anisotropy r is smaller than a predetermined value r1 (second predetermined value). This predetermined value r1 may be the same as the saturation value r0, or may be set to a value different from the saturation value r0. For example, the predetermined value r1 may be set so that it can be determined that the value becomes sufficiently low beyond fluctuations caused by the measurement error. However, r1≤r0 is met. In step S160, steps S140 to S150 are repeated until the anisotropy r measured by the additional dispensing becomes smaller than the predetermined value r1. Here, as illustrated in FIG. 5B, the reaction time T is considered even in the measurement in the additional dispensing. That is, the anisotropy r is measured as a function of the reaction time T after the additional dispensing is made in step S140. The measurement in step S150 may be performed after the reaction time T has elapsed. In a case where the anisotropy r is smaller than the predetermined value r1, the concentration of the measurement object is calculated from the additionally dispensed reagent amount in step S170. Even in step S170, similarly to step S130, the concentration is calculated based on the previously obtained calibration curve. However, in step S170, a second calibration curve obtained by measuring a relationship between the additional dispensing amount and the concentration of the measurement object is used.

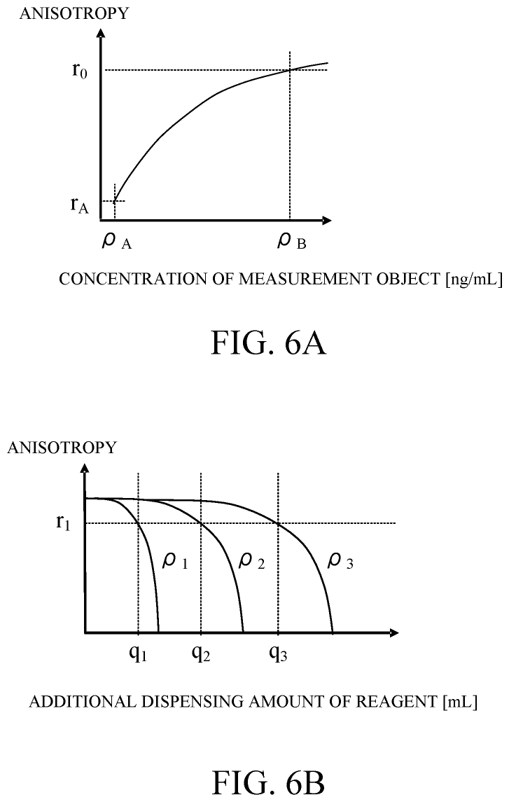

Referring now to FIGS. 6A and 6B, a description will be given of a method of calculating the concentration of the measurement object in steps S130 and S170. FIG. 6A schematically illustrates one example of the first calibration curve for step S130. A horizontal axis represents the concentration of the measurement object, and a vertical axis represents a value of the anisotropy r measured in a case where the measurement object reacts with the reagent in the reagent amount dispensed in the first dispensing. The first calibration curve can be obtained using the above standard sample. A quantifiable range of the concentration of the measurement object using this first calibration curve is from concentration ρA at which measurement result rA above the noise level is obtained to concentration ρB corresponding to the saturation value r0. The measurement result illustrated in FIG. 6A fitted with a proper function may be set to the first calibration curve. FIG. 6B schematically illustrates the second calibration curve for step S170. A horizontal axis represents an additionally dispensed reagent amount. Alternatively, a horizontal axis may represent the total dispensed amount including the reagent amount dispensed in the first dispensing. A vertical axis represents the value of the measured anisotropy r. The second calibration curve can be similarly measured using the standard sample. FIG. 6B illustrates measurement results at the concentration of the measurement object of ρ1, ρ2, and ρ3 (ρ1<ρ2<ρ3), and the additionally dispensed reagent amount in a case where the value of the anisotropy r becomes the reference value r1 is expressed by q1, q2, and q3. Using this measurement result, the concentration ρ1 of the measurement object can be obtained from the dispensed amount q1 corresponding to the anisotropy r1. Data obtained by expressing the concentration ρ as a function of the dispensing amount q from the measurement results in FIG. 6B may be used as the second calibration curve. Alternatively, the reference value r1 may be used as the anisotropy r that is used to calculate the concentration, and another reference r2 (where r2<r1) may be used for the determination in step S160. That is, after the measurement result sufficiently below the reference value r1 is obtained, the additionally dispensed reagent amount that becomes the reference value r1 may be estimated from the measurement result, and the concentration may be calculated using the second calibration curve from the estimated result.

The additionally dispensed amount in dispensing the additional fluorescent bodies affects the resolution of the concentration to be measured. The resolution of the concentration to be measured can be improved by measurement with a smaller additional dispensing amount. On the other hand, in order to widen the measuring range, the number of times of dispensing N may be increased, and the measurement including the reaction time needs a long time. Therefore, the concentration of the measurement object in the saturation range may be determined in consideration of the balance between the resolution for the measurement and the measurement time. The additional dispensing amount does not necessarily have to be equal to the first dispensing amount. The additional dispensing amount can be independently changed. As long as the concentration range of the measurement object is previously known, the dispensing amount for the first dispensing and the dispensing amount for the additional dispensing may be set accordingly.

The fluorescence polarization analyzing apparatus 122 according to this embodiment is not limited to the configuration illustrated in FIG. 3. For example, the fluorescence polarization analyzing apparatus 122 according to this embodiment measures the fluorescent light 91 emitted in the transmitting direction of the excitation light 90 incident on the reaction solution 80, as illustrated in FIG. 3. However, the fluorescence polarization analyzing apparatus 122 according to this embodiment may measure the fluorescent light 91 emitted from the reaction solution 80 in a direction perpendicular to the traveling direction of the excitation light 90 by 90 degrees. Alternatively, the fluorescence polarization analyzing apparatus 122 according to this embodiment may measure the fluorescent light 91 at any angle.

For the configuration that measures the fluorescent light 91 through the polarization direction, once the intensity I// and the intensity II can be measured, the fluorescence polarization measuring method according to this embodiment can be applied. For example, the parallel intensity I// and the orthogonal intensity II may be measured in a time division manner by omitting branching by the half-mirror 73, using a pair of polarizing filters (such as the polarizing filters 71 and 74) on the excitation light side and the fluorescent light side, and rotating the polarizing filter 74.

The fluorescence polarization measuring method according to this embodiment can measure an extremely low concentration of the measurement object with high sensitivity once the size and fluorescence lifespan of the fluorescent body are properly set for the measurement object. In order to maximize this high-sensitivity feature in the low-concentration range, the dispensing reagent amount in the first dispensing may be adjusted according to the measurement limit that allows measurement of the measurement object having the lowest concentration under the condition of the above apparatus configuration. For example, in order to secure sensitivity in measuring the measurement object with low concentration, the fluorescent reagent is adjusted to a very small amount close to the limit of measurement. After the first dispensing amount is adjusted in this way, the additional dispensing step from step S140 to step S170 in this embodiment may be performed for a measurement object in a concentration range that is unmeasurable in the first dispensing. Thereby, a wide measuring range may be realized up to a high-concentration region while maximum sensitivity is maintained for measurement of a measurement object with low concentration.

Thus, the fluorescence polarization measuring method according to this embodiment includes the first sequence (S100 to S130) that executes the dispensing step (S100) and measuring step (S110) and acquires the first result (S120 to S130). The fluorescence polarization measuring method further includes the second sequence (S140 to S170) that repeats the dispensing step (S140) and the measuring step (S150) one or more times, after this first sequence, and acquires the second result (S160 to S170). In a case where the anisotropy r as the first result is smaller than the first predetermined value r0, the first sequence measures the concentration of the measurement object from the first result based on the relationship between the anisotropy r and the dispensing amount of the fluorescent reagent in the first sequence. More specifically, in a case where the anisotropy r as the first result is smaller than the first predetermined value r0, the first sequence calculates the concentration of the measurement object (S130) based on the first calibration curve using the first result. On the other hand, in a case where the first result is larger than or equal to the first predetermined value r0 (S120), the second sequence (S140 to S170) is executed. The second sequence measures the concentration of the measurement object using the second result based on the relationship between the anisotropy r and the dispensing amount of the fluorescent reagent in the second sequence. More specifically, the second sequence acquires the anisotropy r as the second result, and measures the concentration of the measurement object (S170) based on the second calibration curve using the second result and the additionally dispensed reagent amount.

### Second Embodiment

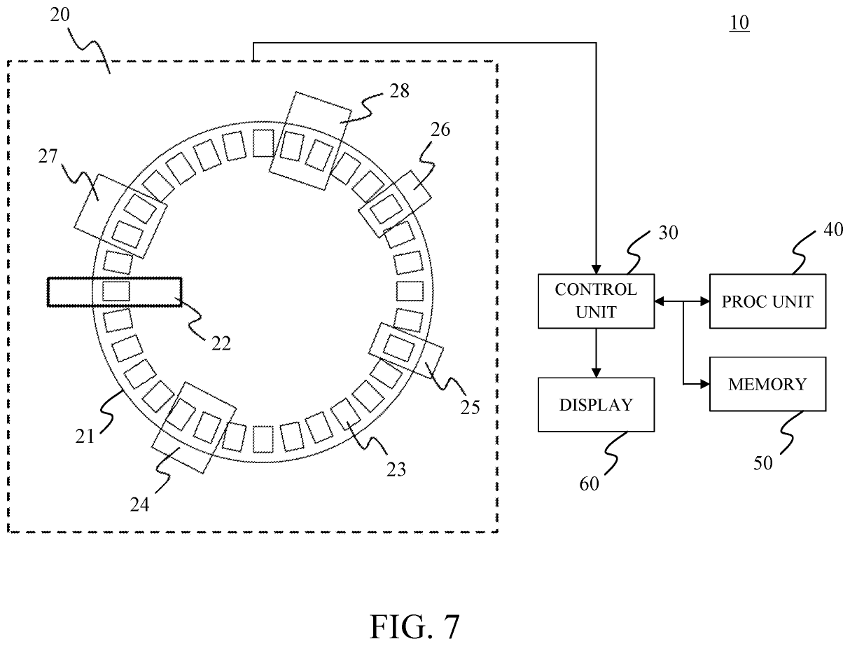

A description will now be given of a second embodiment. FIG. 7 is a configuration diagram of an automatic analyzing apparatus 10 (fluorescence polarization measuring apparatus) that can execute the fluorescence polarization measuring method according to this embodiment. The automatic analyzing apparatus 10 includes an analyzing unit 20 and a control unit 30 configured to control the analyzing unit 20, as disclosed in Japanese Patent Laid-Open No. 2015-007649. The control unit 30 controls the measurement flow in the measuring unit 22, receives a signal output from the measuring unit 22, controls a processing unit 40 and a memory 50, and transfers, processes, and stores data. The automatic analyzing apparatus 10 further includes a display unit 60 configured to display the result processed by the processing unit 40.

The analyzing unit 20 includes a rotatable disc 21 and a plurality of reaction containers 23 arranged on the circumference of the disc 21. The measuring unit 22 has the configuration illustrated in FIG. 3 illustrated in the first embodiment, and measures the anisotropy of fluorescent light for the reaction container 23 that has passed a photometry position during rotation. The analyzing unit 20 further includes a dispenser 24 configured to dispense a sample such as a standard sample and a measurement object into the reaction container 23, a first dispenser 25 configured to dispense a reagent that reacts with the measurement object contained in the sample, and an additional dispenser 26 configured to additionally dispense the reagent. The analyzing unit 20 further includes an agitator 27 configured to agitate the mixed solution of the sample and the reagent, and a cleaner/dryer 28 configured to suck the post-measurement mixed solution from the reaction container 23 and to clean and dry the inside of the reaction container 23. Therefore, the automatic analyzing apparatus 10 can continuously perform a series of flows from dispensing, agitating, measurement, suction, washing, and drying of the sample or reagent while rotating the disc 21. The reaction container 23 is housed in a constant temperature bath, and the temperature of the reaction solution is kept constant.

In the above apparatus configuration, according to the measurement flow illustrated in FIG. 4, the measuring unit 22 measures the anisotropy (S110) for the reaction solution mixed with the reagent dispensed (S100) by the first dispenser 25. The processing unit 40 processes the data to perform the determination of step S120 and the processing of step S130. The additional dispensing in step S140 is performed by the additional dispenser 26, and the measuring unit 22 measures the anisotropy (S150). The processing unit 40 processes the data to perform the determination of step S160 and the processing of step S170. The measurements (S110, S150) are performed multiple times during the rotation of the disc 21 as a function of the reaction time T at the timing when the reaction container 23 passes the measuring unit 22, and the anisotropy is evaluated. Measurement conditions such as the first dispensing amount and the additional dispensing amount have been stored in the memory 50 in advance of measurement, and the control unit 30 reads the measurement condition from the memory 50, if necessary, according to the measurement flow of FIG. 4. The first dispenser 25 may also serve as the additional dispenser 26.

Similarly to the first embodiment, the automatic analyzing apparatus according to this embodiment executes the first sequence (S100 to S130) configured to perform the dispensing step (S100) and the measuring step (S110) and acquires the first result (S120 to S130). In a case where the measured anisotropy r (first result) is smaller than the first predetermined value r0, the first sequence measures the concentration of the measurement object based on the first result using a relationship between the anisotropy r and the dispensing amount of the fluorescent reagent in the first sequence. More specifically, in a case where the measured anisotropy r (first result) is smaller than the first predetermined value r0, the first sequence calculates the concentration of the measurement object (S130) using the first result based on the first calibration curve. On the other hand, in a case where the first result is equal to or larger than the first predetermined value r0 (S120), the automatic analyzing apparatus executes the second sequence (S140 to S170). The second sequence (S140 to S170) repeats the dispensing step (S140) and the measuring step (S150) one or more times after the first sequence and acquires the second result (S160 to S170). The second sequence measures the concentration of the measurement object from the second result based on the relationship between the anisotropy r and the dispensing amount of the fluorescent reagent in the second sequence. More specifically, the second sequence calculates the concentration of the measurement object (S170) based on the second calibration curve using the acquired anisotropy r (second result) and the additionally dispensed reagent amount.

Each embodiment can provide a measuring method that can analyze the concentration of a measurement object with high sensitivity over a wide range from low concentration to high concentration.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2022-145660, filed on Sep. 13, 2022, which is hereby incorporated by reference herein in its entirety.

What is claimed is:

1. A measuring method comprising:
a dispensing step of dispensing fluorescent reagent into a measurement object;
a measuring step of irradiating light onto a reaction solution in which the measurement object and the fluorescent reagent are mixed, and of measuring anisotropy of fluorescent light emitted from the reaction solution;
a first sequence for acquiring a first result about the anisotropy by performing the dispensing step and the measuring step and for measuring concentration of the measurement object from the first result based on a relationship between the anisotropy and a dispensing amount of the fluorescent reagent dispensed in the dispensing step; and
a second sequence for acquiring a second result about the anisotropy by performing the dispensing step and the measuring step one or more times after the first sequence and for measuring the concentration of the measurement object from the second result based on the relationship between the anisotropy and the dispensing amount of the fluorescent reagent dispensed in the dispensing step.

2. The measuring method according to claim 1, wherein the measuring method measures the concentration of the measurement object by the first sequence in a case where the first result is smaller than a first predetermined value.

3. The measuring method according to claim 2, wherein the first sequence measures the concentration of the measurement object based on a first calibration curve indicating a relationship between the concentration of the measurement object and the anisotropy, and the first result, in a case where the first result is smaller than the first predetermined value.

4. The measuring method according to claim 2, wherein the measuring method performs the second sequence in a case where the first result is equal to or larger than the first predetermined value.

5. The measuring method according to claim 1, wherein the second sequence repeats the dispensing step and the measuring step until an anisotropy value becomes smaller than a predetermined value.

6. The measuring method according to claim 5, wherein the second sequence measures the concentration of the measurement object from the second result based on a second calibration curve indicating a relationship between the dispensing amount of the fluorescent reagent and the concentration of the measurement object.

7. The measuring method according to claim 6, wherein the second sequence measures the concentration of the measurement object based on the second calibration curve, the second result, and the dispensing amount of the fluorescent reagent in the second sequence.

8. The measuring method according to claim 1, wherein the dispensing amount of the fluorescent reagent dispensed in the dispensing step of the first sequence and the dispensing amount of the fluorescent reagent dispensed in the dispensing step of the second sequence are equal to each other.

9. The measuring method according to claim 2, wherein the first predetermined value is set based on a value at which the anisotropy is saturated relative to the concentration of the measurement object.

10. The measuring method according to claim 1, wherein the measuring method performs the second sequence in a case where the first result is equal to or larger than a first predetermined value,
wherein the second sequence repeats the dispensing step and the measuring step until an anisotropy value becomes smaller than a second predetermined value, and
wherein the second predetermined value is set to be equal to or smaller than the first predetermined value.

11. The measuring method according to claim 1, wherein the first sequence adjusts the dispensing amount of the fluorescent reagent so as to measure the concentration of the measurement object lower than that in the second sequence.

12. The measuring apparatus comprising:
a reaction container configured to house a reaction solution in which a measurement object and a fluorescent reagent are mixed,
a dispenser configured to dispense the fluorescent reagent into the reaction container;
a measuring unit configured to irradiate the reaction solution with light and to measure anisotropy of fluorescent light emitted from the reaction solution;
a processing unit configured to calculate the concentration of the measurement object using a measurement result obtained by the measuring unit;
a control unit configured to control the dispenser, the measuring unit, and the processing unit;
wherein the control unit is configured to execute:
a first sequence for acquiring a first result about the anisotropy by performing a dispensing step of the fluorescent reagent by the dispenser and a measuring step of measuring the anisotropy by the measuring unit, and for measuring concentration of the measurement object from the first result based on a relationship between the anisotropy and a dispensing amount of the fluorescent reagent dispensed in the dispensing step; and
a second sequence for acquiring a second result about the anisotropy by performing the dispensing step and the measuring step one or more times after the first sequence and for measuring the concentration of the measurement object from the second result based on the relationship between the anisotropy and the dispensing amount of the fluorescent reagent dispensed in the dispensing step.

13. A non-transitory computer-readable storage medium storing a program that causes a computer to execute the measuring method according to claim 1.
